(19) United States
(12) Patent Application Publication
(10) Pub. No.: US 2024/0398181 A1
(43) Pub. Date: Dec. 5, 2024

(54) APPARATUS AND METHODS FOR TOILET TRAINING

(71) Applicant: Mobabbi LLC, Woodbridge, CT (US)

(72) Inventor: Ming Hui, Woodbridge, CT (US)

(73) Assignee: Mobabbi LLC, Woodbridge, CT (US)

(21) Appl. No.: 18/325,952

(22) Filed: May 30, 2023

(51) Int. Cl. A47K 11/02; G09B 5/04

(52) U.S. Cl. CPC A47K 11/02; G09B 5/04

(57) ABSTRACT

Apparatus and methods are provided for toilet training infants. The apparatus presented comprises a training toilet with frame and removeable bowl, and sensors and a controller for detecting waste. The methods taught comprise a training method and a cueing method, for use with infants. A parent may use the apparatus with an infant, to train the infant to use the toilet, and to cue the infant to use the toilet. As the infant uses the toilet and learns, the infant may use the training toilet independently. The present invention solves problems with the currently available apparatuses and methods of toilet training young children, in particular with toilet training of infants.

### FIELD OF THE INVENTION

The presently disclosed subject matter relates to providing apparatus and methods for toilet training children, and more particularly, to apparatus and methods for toilet training infants using conditioning and communication.

### BACKGROUND OF THE INVENTION

When parenting, a parent must teach their babies how to use a toilet. Doing so saves time, expense, and hassle. If a parent can teach a child at an earlier age than is typically used, the savings in time, money, and cleanup are considerable. Prior art devices for toilets made for toddlers exists, such as the “Intelligent Potty”, a “Princess Potty” toilet, a “Summer My Size Potty” toilet, a “Mini Potty for Elimination”, and a “BabyBjöm Smart Potty”, all disclosed in the Information Disclosure Statement by Applicant filed with this application. These items of prior art exhibit multiple shortcomings: they are for toilet-training toddlers, not infants, and do not provide potty training education. Most of the prior art are designed for toddler training, rather than early infant training, and accordingly do not have physical features to accommodate infants. Furthermore, prior art training toilets do not provide or assist with a toilet training solution. The prior art does not assist parents with toilet training strategies.

### SUMMARY OF THE INVENTION

The present invention meets all these needs, by disclosing apparatus for toilet training an infant, and by disclosing methods for training an infant to eliminate waste, and methods for cueing an infant to eliminate waste. The present invention further addresses the problem of other toilets and potties for toddlers.

The present invention addresses the problems of the prior art, which do not present apparatus for conditioning infants to use a potty.

The present invention provides a toilet training solution for early toilet training. An advantage of the apparatus and methods presently disclose is that they enable earlier toilet training, by helping to toilet train infants. Earlier toilet training helps parents save time and money. Earlier toilet training helps protect the environment through reduced diaper use—whether the parents use disposable diapers or washable reusable diapers, the environmental impact is large.

Other toilets on the market, which are primarily for toddlers and not for infants, do not provide potty training education. Most of the prior art are designed for toddler training, rather than early infant training. The infant training toilet described herein, with the methods described herein, teach a complete toilet training solution without the parent having any prior experience with elimination communication or other toilet training strategies.

In one aspect, the present disclosure teaches a toilet training apparatus for toilet training an infant, the toilet training apparatus comprising a toilet frame, a bowl, one or more stabilizer components, and a front support bar, and one or more contact sensors.

In one aspect, the present disclosure teaches a toilet training apparatus wherein the front support bar is removeable, being attachable and detachable from the toilet frame at a frame-bar connector.

In one aspect, the present disclosure teaches a toilet training apparatus wherein the front support bar comprises a single unit.

In one aspect, the present disclosure teaches a toilet training apparatus wherein the front support bar comprises a support-upright, a first support side, and a second support side, and wherein the support-upright is reversibly attachable to and removeable from the frame-bar connector, and the first support side and the second support side are reversibly attachable to and removeable from the support-upright.

In one aspect, the present disclosure teaches a toilet training apparatus wherein the front support bar is advantageously adjustable for a height of the front support bar, for a width of the front support bar, and for a depth of the front support bar.

In one aspect, the present disclosure teaches a toilet training apparatus wherein the one or more stabilizer components comprise one or more base, and/or one or more suction cups, and/or one or more non-slip elements.

In one aspect, the present disclosure teaches a toilet training apparatus wherein the one or more base extends laterally beyond the toilet frame.

In one aspect, the present disclosure teaches a toilet training apparatus wherein the one or more base can be reversibly swapped or used together, and wherein the one or more base are of different heights.

In one aspect, the present disclosure teaches a toilet training apparatus wherein the toilet frame has lateral sides that are tapered as they rise relative to a floor.

In one aspect, the present disclosure teaches a toilet training apparatus wherein the one or more contact sensors are comprised in, on, under, and/or embedded in the toilet frame and/or the bowl.

In one aspect, the present disclosure teaches a toilet training apparatus wherein the toilet training apparatus further comprises a controller, and wherein the controller further comprises one or more speakers, operably connected to the controller; one or more batteries; and one or more switches, and wherein the controller is operably connected to the one or more contact sensors, and wherein the one or more contact sensors, the one or more speakers, and the one or more switches are powered by the one or more batteries.

In one aspect, the present disclosure teaches a toilet training apparatus wherein an electric power from the one or more batteries to the one or more contact sensors is activated and deactivated by the one or more switches.

In one aspect, the present disclosure teaches a toilet training apparatus wherein the one or more switches are connected to a weight sensor, such that the toilet training apparatus activates when the infant sits on the toilet training apparatus.

In one aspect, the present disclosure teaches a toilet training apparatus wherein the one or more switches are internal to the toilet frame.

In one aspect, the present disclosure teaches a toilet training apparatus wherein the one or more switches are situated such that the one or more switches may be activated by a parent.

In one aspect, the present disclosure teaches a toilet training apparatus wherein the toilet training apparatus further comprises a mobile app, having an app database on or accessible by the mobile app, wherein the mobile app connects with the controller, and wherein the mobile app stores a plurality of elimination information at or after each elimination instance in the app database.

A toilet training apparatus for toilet training an infant with one or more methods for toilet training, the toilet training apparatus comprising: a toilet frame; a bowl; a base; a front support bar; one or more contact sensors, wherein the one or more contact sensors are comprised in, on, under, and/or embedded in the toilet frame and/or the bowl; and a controller, wherein the controller further comprises one or more speakers, operably connected to the controller; one or more batteries; and one or more switches, and wherein the controller is operably connected to the one or more contact sensors, and wherein the one or more contact sensors, the one or more speakers, and the one or more switches are powered by the one or more batteries; and wherein the one or more methods may comprise a recording mode, a training mode, and/or a cueing mode.

In one aspect, the present disclosure teaches a toilet training apparatus wherein the recording mode comprises a recording method wherein the controller records a sound in a recording step, the controller receives the sound, the controller records the sound, and the controller stores the sound.

In one aspect, the present disclosure teaches a toilet training apparatus wherein the training mode comprises a training method wherein the one or more contact sensors detect a waste, in a detection step; thereafter the one or more contact sensors cause the controller to activate a training, wherein the training comprises the controller causing the one or more speakers to play a sound, in which the sound is to be used to train the infant; and in which the controller sends information on the training mode and usage thereof to a mobile app in a sending step, with the information to be stored in an app database on the mobile app.

In one aspect, the present disclosure teaches a toilet training apparatus wherein the cueing mode comprises a cueing method wherein the toilet training apparatus initiates a sound to cue the infant to eliminate into the toilet training apparatus; and after the infant has eliminated waste in an elimination instance, and the toilet training apparatus so detects in a detecting step, the cueing method stops the sound, and the cueing method thereafter sends information on the elimination instance to a mobile app from the controller, in a sending step, with the information to be stored in an app database on the mobile app.

In one aspect, the present disclosure teaches a toilet training apparatus wherein the toilet training apparatus further comprises a mobile app, having an app database on or accessible by the mobile app, wherein the mobile app connects with the controller, and wherein the mobile app stores a plurality of elimination information at or after each elimination instance in the app database.

In one aspect, the present disclosure teaches a toilet training apparatus wherein a parent can use the mobile app to initiate a sound to cue the infant.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various aspects, is better understood when read in conjunction with the appended drawings. For the purposes of illustration, the drawings show exemplary aspects; but the presently disclosed subject matter is not limited to the specific methods and instrumentalities disclosed. In the drawings, like reference characters generally refer to the same components or steps of the device throughout the different figures. In the following detailed description, various aspects of the present invention are described with reference to the following drawings, in which:

FIG. 1 shows a front and top perspective view of an aspect of the apparatus of the present invention.

FIG. 2 shows a front and top exploded perspective view of an aspect of the apparatus of the present invention.

FIG. 3 shows a cross-sectional perspective view of an aspect of the apparatus of the present invention.

FIG. 4 shows a rear and top perspective view of an aspect of the apparatus of the present invention.

FIG. 5 shows a top perspective view of an aspect of the apparatus of the present invention.

FIG. 6 shows a front elevation view of an aspect of the apparatus of the present invention.

FIG. 7 shows a side elevation view of an aspect of the apparatus of the present invention.

FIG. 8 shows a rear elevation view of an aspect of the apparatus of the present invention.

FIG. 9 shows a side elevation view of an aspect of the apparatus of the present invention.

FIG. 10 shows a top plan view of an aspect of the apparatus of the present invention.

FIG. 11 shows a cross-sectional view of an aspect of the apparatus of the present invention.

FIG. 12 shows a front and top perspective view of a component of an aspect of the apparatus of the present invention.

FIG. 13 shows a front and top exploded perspective view of a component of an aspect of the apparatus of the present invention.

FIG. 14 shows a front elevation view of a component of an aspect of the apparatus of the present invention.

FIG. 15 shows a top plan view of a component of an aspect of the apparatus of the present invention.

FIG. 16 shows a front and top perspective view of an aspect of the apparatus of the present invention.

FIG. 17 shows a front and top perspective view of an aspect of the apparatus of the present invention.

FIG. 18 shows a cross-sectional view of an aspect of the apparatus of the present invention.

FIG. 19 shows a cross-sectional view of an aspect of the apparatus of the present invention.

FIG. 20 shows a method of implementing the apparatus of the present disclosure.

FIG. 21 shows a method of implementing the apparatus of the present disclosure.

FIG. 22 shows a method of implementing the apparatus of the present disclosure.

FIG. 23 shows an exemplary operating environment of the present disclosure.

### DETAILED DESCRIPTION OF THE DRAWINGS

The presently disclosed invention is described with specificity to meet statutory requirements. But, the description itself is not intended to limit the scope of this patent. Rather, the claimed invention might also be configured in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described. The word “approximately” as used herein means within 5% of a stated value, and for ranges as given, applies to both the start and end of the range of values given.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of use of the present invention.

The present invention comprises a toilet training apparatus 100, for toilet training infants using conditioning and communication. The toilet training apparatus 100 facilitates the use of communication regarding elimination (the infant's elimination of waste), that is, the practice of learning the infant's signals, and using cues to teach the infant to associate the toilet training apparatus 100 with elimination. The toilet training apparatus 100 supports this practice as a Wi-Fi-enabled, or Bluetooth-enabled, or otherwise Internet-connected or Internet-of-Things, smart potty designed to help busy parents teach their babies how to use the toilet training apparatus 100 with confidence using sensors, cues, and signals. This can be done with an infant at a much younger age than is typically practiced, in the known art. There is also an option of logging progress on a mobile app, which communicates with the rest of the toilet training apparatus 100.

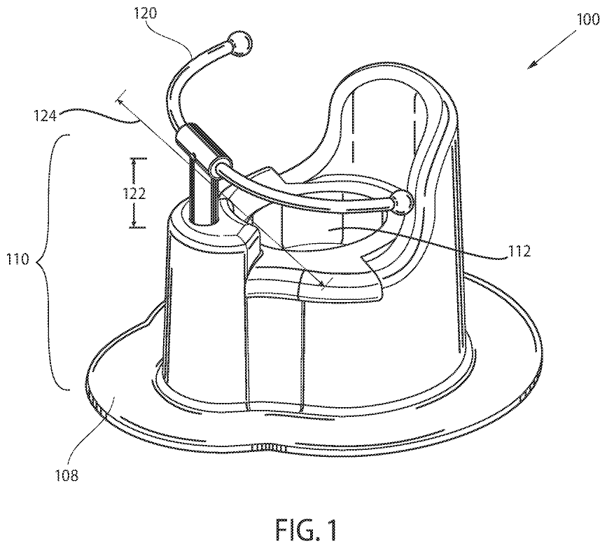

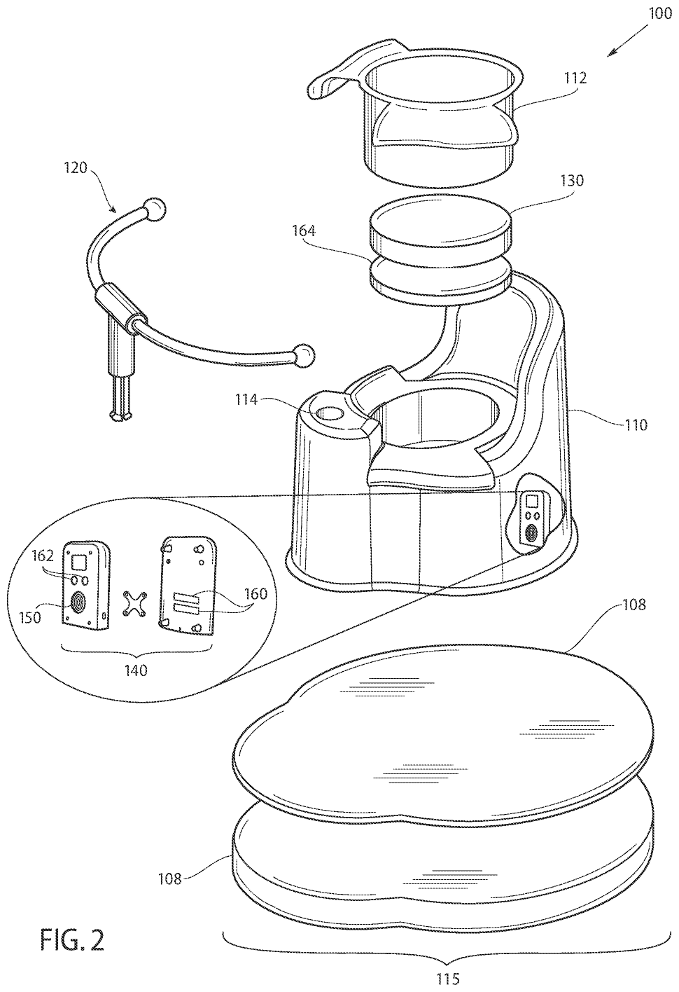

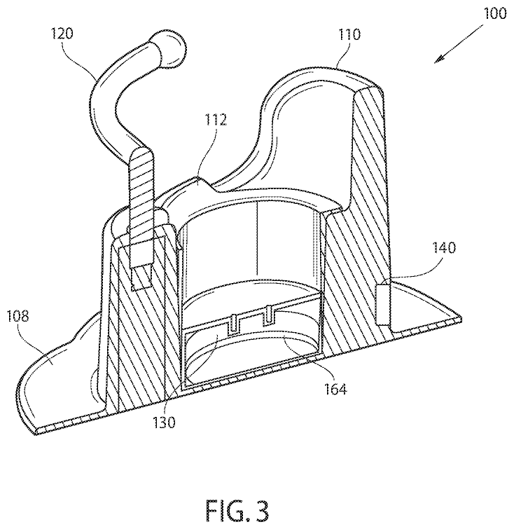

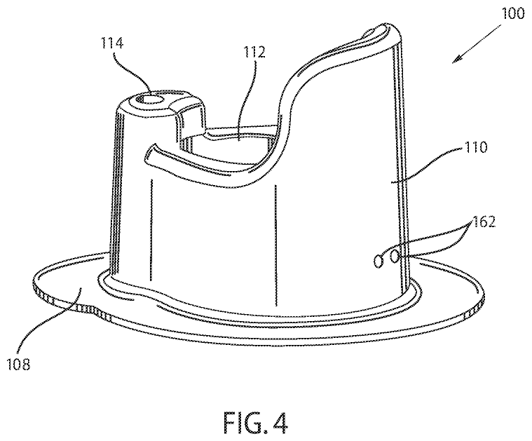

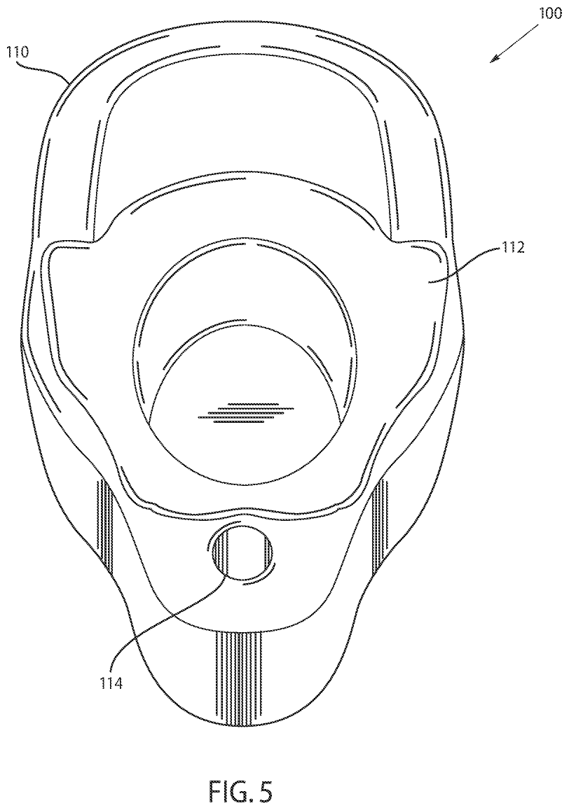

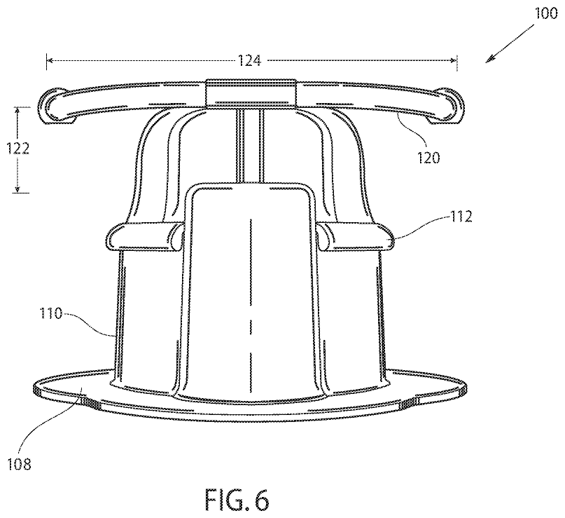

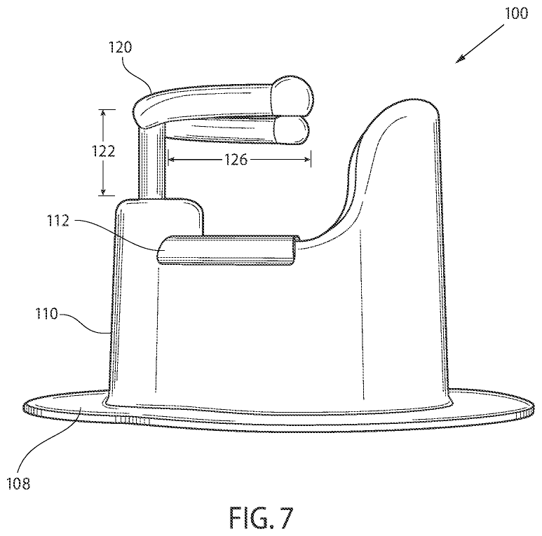

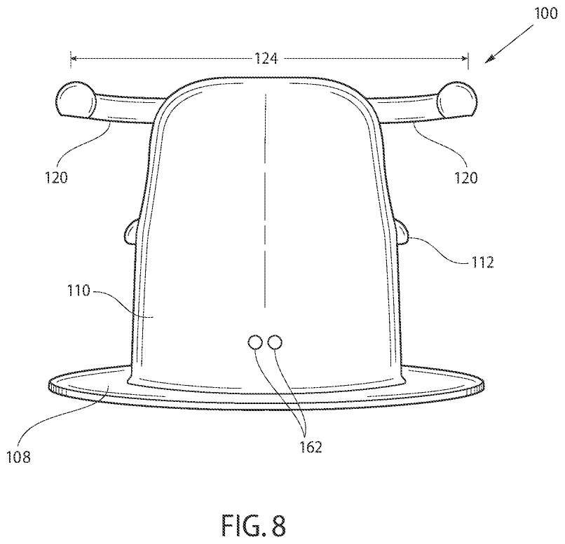

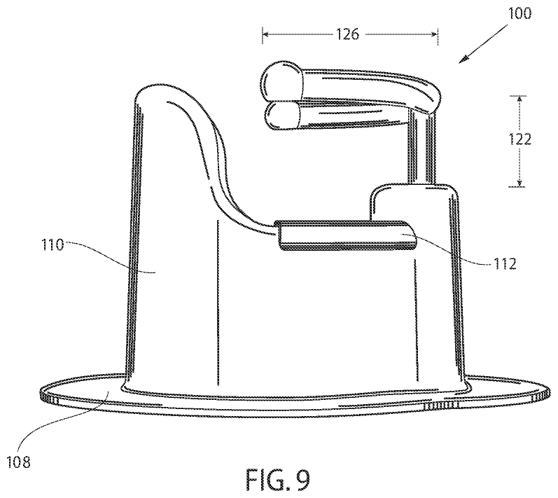

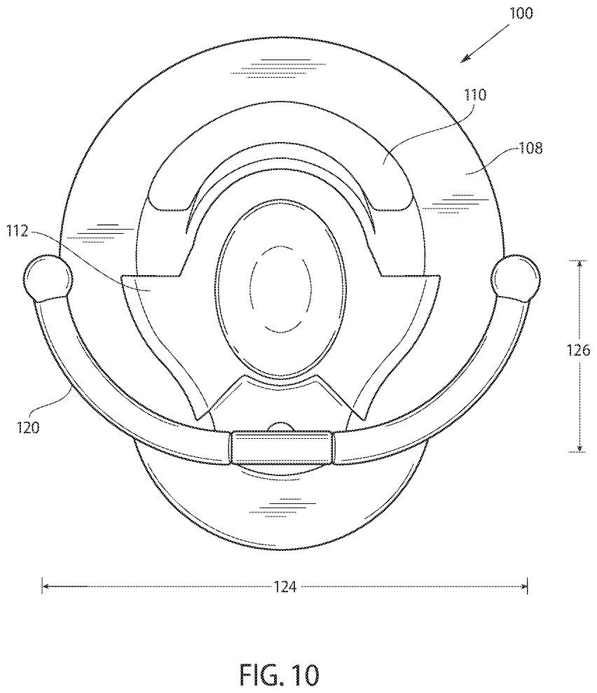

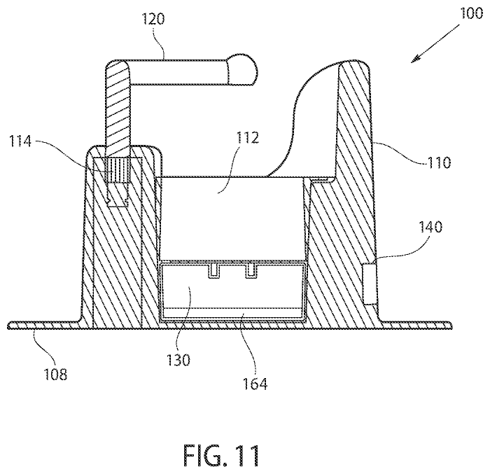

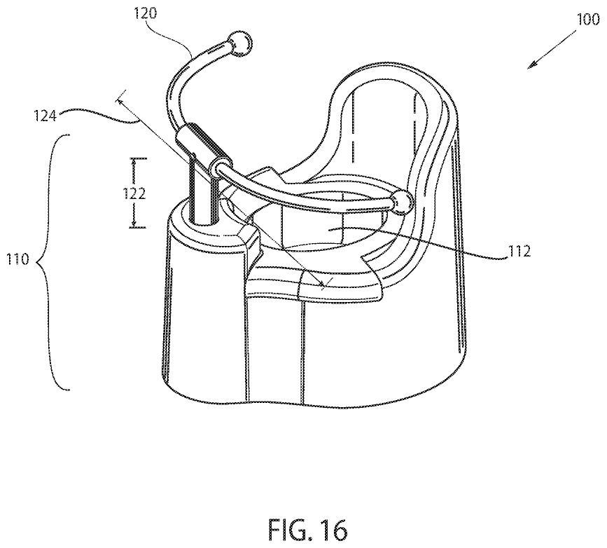

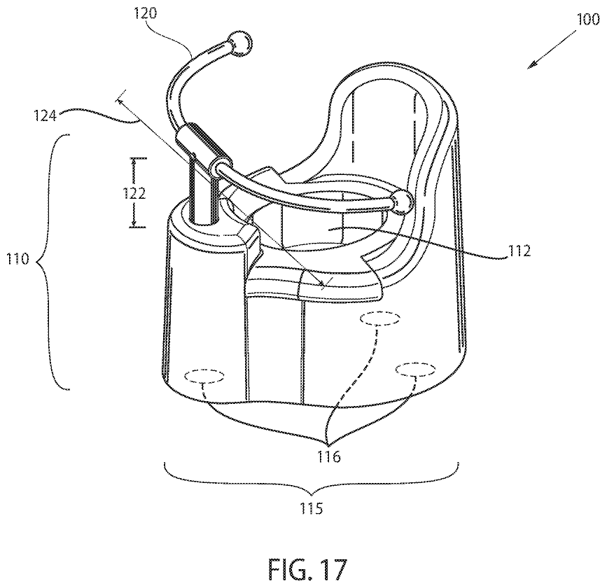

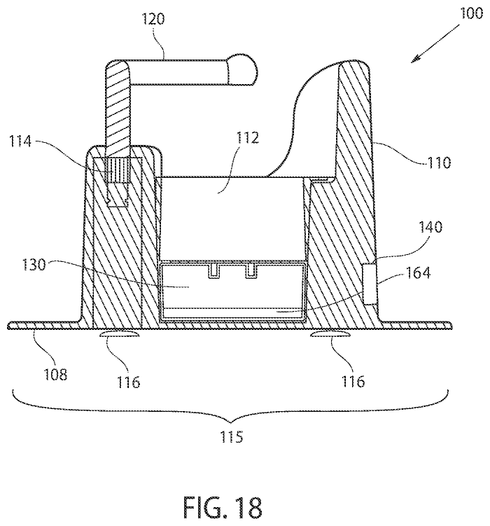

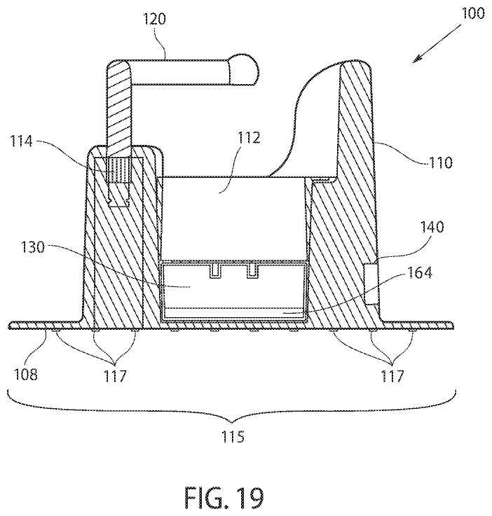

With reference to FIG. 1, FIG. 2, FIG. 3, FIG. 4, FIG. 5, FIG. 6, FIG. 7, FIG. 8, FIG. 9, FIG. 10, FIG. 11, FIG. 16, FIG. 17, FIG. 18, and FIG. 19 the toilet training apparatus 100 of the present invention comprises a toilet frame 110 and a bowl 112. In some aspects, the toilet training apparatus 100 may comprise one or more base 108. In some aspects of the present disclosure, the toilet training apparatus 100 may comprise one or more base 108 which may be reversibly swapped, or used together, wherein the one or more base 108 may be of different heights or thicknesses, to allow the overall height of the toilet training apparatus 100 to be adjusted. The adjustability of the height of the toilet training apparatus 100, specifically the height at which an infant 300 sits on the bowl 112, is important, as infants grow quickly, and because infants require a seat height that is different than—and lower than—a seat height that is typically required for toddlers and pre-school age children. Other mechanisms for height-adjustability of the toilet training apparatus 100 may be implemented, including but not limited to ratcheting or locking mechanisms for the toilet frame 110, including possible implementations wherein the toilet frame 110 comprises multiple components such that the multiple components of the toilet frame 110 may be raised and lowered relative to each other, allowing for height adjustability of the toilet training apparatus 100. In some aspects of the present disclosure, the toilet training apparatus 100 may comprise one or more components for stabilizing the toilet training apparatus 100 on the floor or surface on which it is placed, referred to as one or more stabilizer components 115. The one or more stabilizer components 115 may comprise one or more of a base 108, one or more suction cups 116, one or more non-slip elements 117, or other components for stabilizing the toilet training apparatus 100 to the floor, now known or later invented.

The toilet frame 110 is sized for infants and young babies, and advantageously is shaped to be comfortable to sit on. The bowl 112 is removeable, from the toilet frame 110, so that the bowl 112 can be easily cleaned. The toilet frame 110 may have lateral sides that are vertical or approximately vertical, or the toilet frame 110 may have lateral sides that are tapered as they rise relative to the floor or the base 108, such that the upper portions of the toilet frame 110 are narrower and/or tapered relative to the bottom portions of the toilet frame 110, that is, the portions of the toilet frame 110 that are closer to or at the floor or the base 108. The base 108 may extend laterally beyond the toilet frame 110 or may be approximately coterminous with the toilet frame 110 at a lateral extent of the toilet frame 110, being the outside surfaces or edges of the toilet frame 110. The base 108, whatever its size or size relative to the toilet frame 110, may be heavy, to prevent the toilet training apparatus 100 from tipping by stabilizing the toilet training apparatus 100, or may not be weighted to be heavy. In some aspects of the present disclosure, the toilet training apparatus 100 may comprise one or more suction cups 116. The one or more suction cups 116 may be affixed to or attachable to the underside of the base 108 or one or more base 108, or the one or more suction cups 116 may be affixed to or attachable to the underside of the toilet frame 110. The one or more suction cups 116 serve to prevent the toilet training apparatus 100 from tipping, or to reduce the risk of tipping, by stabilizing the toilet training apparatus 100. In some aspects of the present disclosure, the toilet training apparatus 100 may comprise one or more non-slip elements 117. The one or more non-slip elements 117 may be affixed to or attachable to the underside of the base 108, or the one or more non-slip elements 117 may be affixed to or attachable to the underside of the toilet frame 110. The one or more non-slip elements 117 serve to prevent the toilet training apparatus 100 from slipping, or to reduce the risk of slipping, by stabilizing the toilet training apparatus 100.

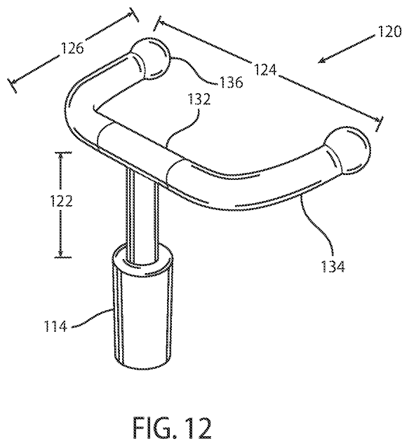

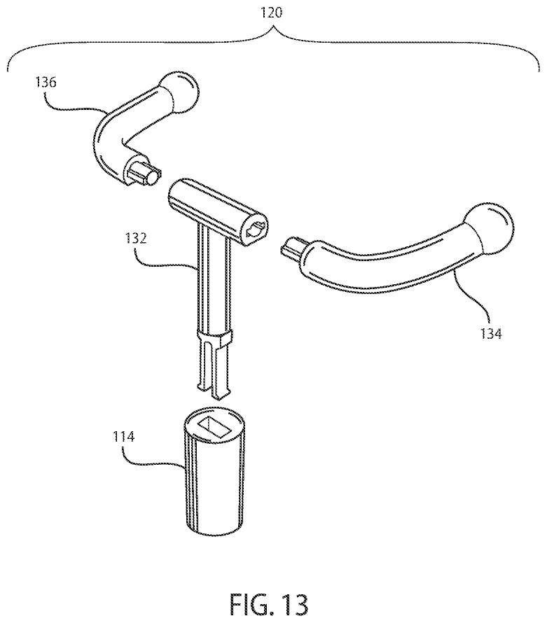

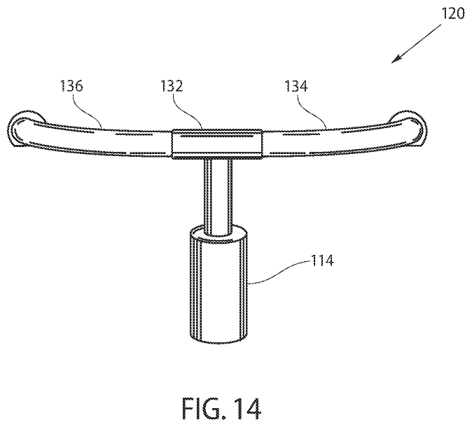

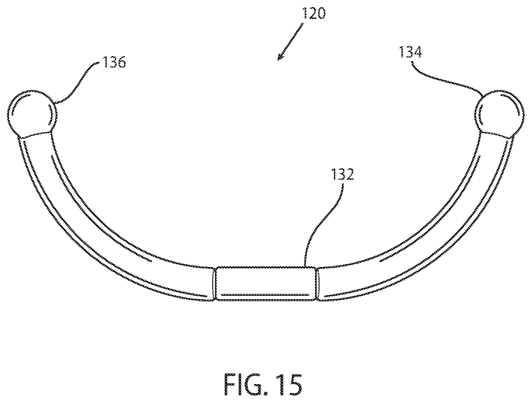

With further reference to FIG. 12, FIG. 13, FIG. 14, and FIG. 15, the toilet training apparatus 100 comprises a front support bar 120, wherein the front support bar 120 is advantageously removable, relative to the other components of the toilet training apparatus 100, being attachable and detachable from the toilet frame 110 at a frame-bar connector 114, the frame-bar connector 114 being comprised in the toilet frame 110. The front support bar 120 may comprise a single unit, or in some aspects the front support bar 120 may comprise a support-upright 132, a first support side 134, and a second support side 136. The support-upright 132 may reversibly be attached to and removed from the frame-bar connector 114, and the first support side 134 and the second support side 136 may reversibly be attached to and removed from the support-upright 132. The front support bar 120 is advantageously adjustable for a height 122 of the front support bar 120, by adjusting a height of the support-upright 132 in aspects of the present disclosure with the support-upright 132, and/or for a width 124 of the front support bar 120, and/or for a depth 126 of the front support bar 120, relative to the toilet frame 110 at the frame-bar connector 114, by adjusting a width and/or a depth of the support-upright 132 and/or the first support side 134 and the second support side 136. The front support bar 120 assists in preventing the infant from falling, forward and/or to either side. Before an infant can sit independently unsupported, a parent (or any person, the word “parent” is used throughout the present disclosure to mean a person assisting the infant) can hold an infant 300 in a squatting position above the toilet frame 110 and bowl 112, and train the infant 300 to eliminate into the toilet training apparatus 100 without the front support bar 120. This can be practiced from birth of the infant. When the infant 300 is able to sit independently without support, which is typically around 6 months old for most infants, the parent can place the infant 300 on the toilet training apparatus 100 and then attach the front support bar 120. The front support bar 120 may, advantageously, have toys attached to, and removed from, the front support bar 120. The toys can keep the infant 300 entertained while she eliminates into the toilet training apparatus 100. As the infant 300 ages and becomes more mobile and stronger, the front support bar 120 can be removed.

With further reference to FIG. 2, FIG. 3, FIG. 11, FIG. 18, and FIG. 19, the toilet training apparatus 100 further comprises one or more contact sensors 130. The one or more contact sensors 130 may comprise weight sensors, conductivity sensors, or other sensors now known or later invented. The one or more contact sensors 130 may be in, on, under, and/or embedded in the toilet frame 110 and/or the bowl 112. The toilet training apparatus 100 may further comprise a controller 140, wherein the controller 140 may further comprise one or more speakers 150, operably connected to the controller 140; one or more batteries 160; and one or more switches 162. The controller 140 is operably connected to the one or more contact sensors 130. The one or more contact sensors 130, the one or more speakers 150, and the one or more switches 162 are advantageously powered by one or more batteries 160. It has been found advantageous to have an electric power from the one or more batteries 160 to the one or more contact sensors 130 be activated and/or deactivated by the one or more switches 162. By having the electric power to the one or more contact sensors 130 be activated or deactivated, the toilet training apparatus 100 can both conserve battery power, and can prevent the one or more contact sensors 130 from being triggered by any items in the bowl 112, wherein such items may not be waste 310. The one or more switches 162 may be manually activated, such as by the parent, and/or the one or more switches 162 may be connected to a weight sensor 164 such that the toilet training apparatus 100 activates when the infant sits on the toilet training apparatus 100. The one or more switches 162 may be internal to the toilet frame 110, or may be situated such that the one or more switches 162 may be activated by a parent, in or on an external surface of the toilet frame 110 advantageously, such as is depicted with reference to FIG. 4 and FIG. 8, or in or on another surface of the toilet training apparatus 100.

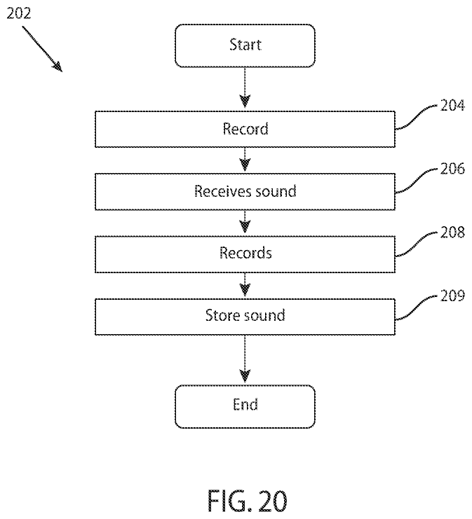

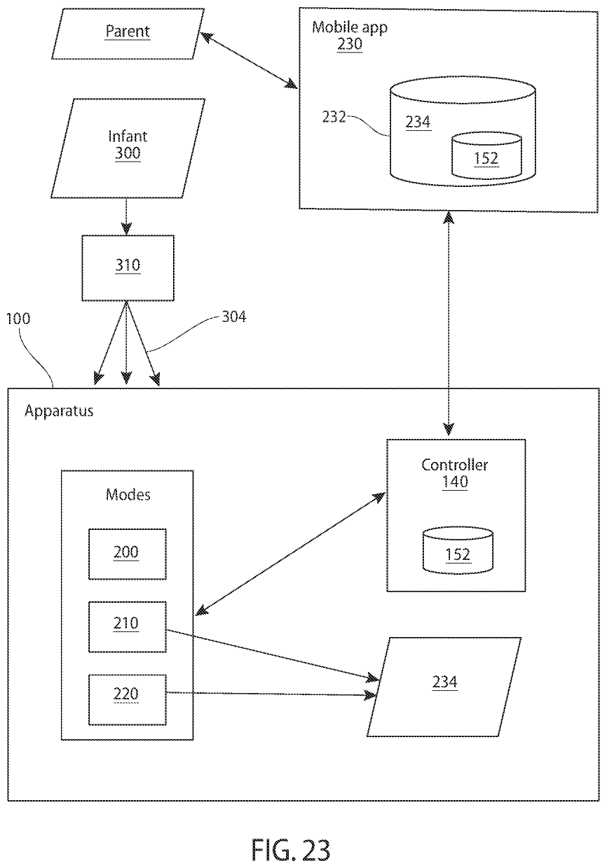

With reference to FIG. 20 and FIG. 23, the toilet training apparatus 100 can be used in a recording mode 200, to assist in teaching an infant 300 to use a toilet to eliminate waste 310. In the recording method 202 of the recording mode 200, the parent activates the controller 140 to prepare to record a sound 152 in a recording step 204, wherein the sound 152 may be used for cueing the infant 300. In some aspects of the present disclosure, the recording step 204 may be implemented using a mobile app 230, which can thereafter send the sound 152 to the controller 140. Advantageously, the sound 152 may be a sound like “shhh”, but could be any sound which the parent desires to use to train the infant 300. The parent may then produce the sound 152, and the controller 140 receives 206 the sound 152. The controller 140 records 208 the sound 152. The controller 140 thereafter stores 209 the sound 152.

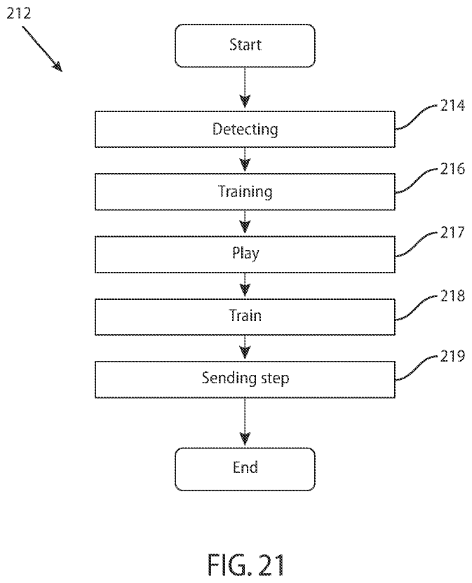

With reference to FIG. 21 and FIG. 23, the toilet training apparatus 100 can be used in a training mode 210, for use with an infant before the infant has been trained. In the training method 212 of the training mode 210, when or after the infant 300 eliminates waste 310 into the toilet training apparatus 100, the one or more contact sensors 130 detect the waste 310, in a detection step 214, that the infant has eliminated. The one or more contact sensors 130 thereafter cause the controller 140 to activate a training 216. The training 216 may comprise the controller 140 causing the one or more speakers 150 to play 217 a sound 152, for instance such as “shhh”, in which the sound 152 is to be used to train 218 the infant to associate the sound 152 with elimination into the toilet training apparatus 100. The sound 152 will, advantageously, play 217 every time the infant 300 eliminates into the toilet training apparatus 100 while in the training mode 210. The training method 212 may thereafter send information on the training mode 210 and usage thereof to the mobile app 230 in a sending step 219 from the controller 140, with such information to be stored in the app database 232.

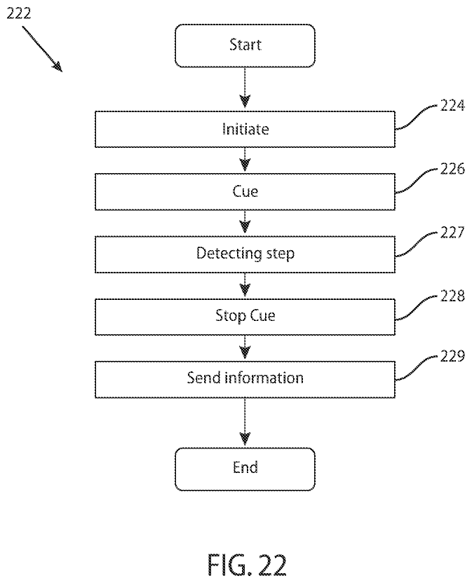

With reference to FIG. 22 and FIG. 23, after an infant 300 has been trained, the toilet training apparatus 100 can be set to a cueing mode 220. In the cueing mode 220, the toilet training apparatus 100 operates a cueing method 222 for cueing the infant 300 for use of the toilet training apparatus 100. The toilet training apparatus 100 will initiate 224 the sound 152 to cue 226 the infant 300 to eliminate into the toilet training apparatus 100. As the infant 300 gets older and has learned to use the toilet training apparatus 100 with the association with the sound 152, the infant 300 can be taught to use the toilet training apparatus 100 independently by removing or pulling down his or her pants or shorts, and sitting on the toilet training apparatus 100 to eliminate. After the infant has eliminated waste 310, and the toilet training apparatus 100 so detects in a detecting step 227, the cueing method 222 stops 228 the sound 152 that was a cue for the infant 300. The cueing method 222 may thereafter send information on the elimination instance 304 to the mobile app 230 from the controller 140, in a sending step 229, with such information to be stored in the app database 232.

The cueing method 222 of the cueing mode 220 assists the parent of the infant 300, by teaching the parent or parents that when the cueing method 222 initiates 224 the sound 152, the infant 300 learns to eliminate. The parents can thus learn to play the sound 152, which can be initiated from a mobile app, and thereby cues 226 the infant 300 to eliminate.

With reference to FIG. 23, the toilet training apparatus 100 may comprise, or may in some aspects be accompanied by, a mobile app 230. The mobile app 230 can connect with the controller 140, advantageously via Wi-Fi or other communications protocols. The mobile app 230 may provide education to the parent on elimination communication, to assist the infant 300 in toilet training and conditioning, utilizing information stored in an app database 232. The mobile app 230 may track the toilet training progress of the infant 300, storing a plurality of elimination information 234 at or after each elimination instance 304, that is, when the infant 300 eliminates waste 310, in the app database 232. The plurality of elimination information 234 may comprise a time, a duration the infant 300 was on the toilet training apparatus 100, and one or more types and a mass of waste 310. The app database 232 may also store the sound 152. The toilet training apparatus 100 can function with or without the mobile app 230. With the convenience of the mobile app 230, the parent can switch between recording mode 200, training mode 210, and cueing mode 220, using the mobile app 230, and the parent can use the mobile app 230 to initiate 224 the sound 152 to cue 226 the infant 300 to eliminate into the toilet training apparatus 100. The mobile app 230 may also track the timing of elimination by the infant 300, by creating a log of information, comprising at least information on time of the eliminations, which allows the parent to figure out the infant's schedule for elimination, storing the foregoing in the plurality of elimination information 234 in the app database 232. The app database 232 may be stored locally on the mobile app 230 and/or backed up remotely, such that the app database 232 is accessible by the mobile app 230. The mobile app 230 may also offer helpful toilet training tips, and may offer a forum for parents to share their toiled training experiences.

Certain aspects of the present invention were described above. From the foregoing it will be seen that this invention is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A toilet training apparatus for toilet training an infant, the toilet training apparatus comprising a toilet frame, a bowl, one or more stabilizer components, and a front support bar, and one or more contact sensors.

2. The toilet training apparatus of claim 1, wherein the front support bar is removeable, being attachable and detachable from the toilet frame at a frame-bar connector.

3. The toilet training apparatus of claim 2, wherein the front support bar comprises a single unit.

4. The toilet training apparatus of claim 2, wherein the front support bar comprises a support-upright, a first support side, and a second support side, and wherein the support-upright is reversibly attachable to and removeable from the frame-bar connector, and the first support side and the second support side are reversibly attachable to and removeable from the support-upright.

5. The toilet training apparatus of claim 1, wherein the front support bar is advantageously adjustable for a height of the front support bar, for a width of the front support bar, and for a depth of the front support bar.

6. The toilet training apparatus of claim 1, wherein the one or more stabilizer components comprise one or more base, and/or one or more suction cups, and/or one or more non-slip elements.

7. The toilet training apparatus of claim 6, wherein the one or more base extends laterally beyond the toilet frame.

8. The toilet training apparatus of claim 6, wherein the one or more base can be reversibly swapped or used together, and wherein the one or more base are of different heights.

9. The toilet training apparatus of claim 1, wherein the toilet frame has lateral sides that are tapered as they rise relative to a floor.

10. The toilet training apparatus of claim 1, wherein the one or more contact sensors are comprised in, on, under, and/or embedded in the toilet frame and/or the bowl.

11. The toilet training apparatus of claim 1, wherein the toilet training apparatus further comprises a controller, and wherein the controller further comprises one or more speakers, operably connected to the controller; one or more batteries; and one or more switches, and wherein the controller is operably connected to the one or more contact sensors, and wherein the one or more contact sensors, the one or more speakers, and the one or more switches are powered by the one or more batteries.

12. The toilet training apparatus of claim 11, wherein an electric power from the one or more batteries to the one or more contact sensors is activated and deactivated by the one or more switches.

13. The toilet training apparatus of claim 11, wherein the one or more switches are connected to a weight sensor, such that the toilet training apparatus activates when the infant sits on the toilet training apparatus.

14. The toilet training apparatus of claim 11, wherein the one or more switches are internal to the toilet frame.

15. The toilet training apparatus of claim 11, wherein the one or more switches are situated such that the one or more switches may be activated by a parent.

16. The toilet training apparatus of claim 11, wherein the toilet training apparatus further comprises a mobile app, having an app database on or accessible by the mobile app, wherein the mobile app connects with the controller, and wherein the mobile app stores a plurality of elimination information at or after each elimination instance in the app database.

17. A toilet training apparatus for toilet training an infant with one or more methods for toilet training, the toilet training apparatus comprising:
a toilet frame;
a bowl;
a base;
a front support bar;
one or more contact sensors, wherein the one or more contact sensors are comprised in, on, under, and/or embedded in the toilet frame and/or the bowl; and
a controller, wherein the controller further comprises one or more speakers, operably connected to the controller; one or more batteries; and one or more switches, and wherein the controller is operably connected to the one or more contact sensors, and wherein the one or more contact sensors, the one or more speakers, and the one or more switches are powered by the one or more batteries; and
wherein the one or more methods may comprise a recording mode,
a training mode, and/or a cueing mode.

18. The toilet training apparatus of claim 17, wherein the recording mode comprises a recording method wherein the controller records a sound in a recording step, the controller receives the sound, the controller records the sound, and the controller stores the sound.

19. The toilet training apparatus of claim 17, wherein the training mode comprises a training method wherein the one or more contact sensors detect a waste, in a detection step; thereafter the one or more contact sensors cause the controller to activate a training, wherein the training comprises the controller causing the one or more speakers to play a sound, in which the sound is to be used to train the infant; and in which the controller sends information on the training mode and usage thereof to a mobile app in a sending step, with the information to be stored in an app database on the mobile app.

20. The toilet training apparatus of claim 17, wherein the cueing mode comprises a cueing method wherein the toilet training apparatus initiates a sound to cue the infant to eliminate into the toilet training apparatus; and after the infant has eliminated waste in an elimination instance, and the toilet training apparatus so detects in a detecting step, the cueing method stops the sound, and the cueing method thereafter sends information on the elimination instance to a mobile app from the controller, in a sending step, with the information to be stored in an app database on the mobile app.

21. The toilet training apparatus of claim 17, wherein the toilet training apparatus further comprises a mobile app, having an app database on or accessible by the mobile app, wherein the mobile app connects with the controller, and wherein the mobile app stores a plurality of elimination information at or after each elimination instance in the app database.

22. The toilet training apparatus of claim 21, wherein a parent can use the mobile app to initiate a sound to cue the infant.
